(19) United States
(12) Patent Application Publication
(10) Pub. No.: US 2018/0276314 A1
(43) Pub. Date: Sep. 27, 2018

(54) PAGE DISPLAY METHOD AND SYSTEM

(71) Applicants: BEIJING JINGDONG SHANGKE INFORMATION TECHNOLOGY CO., LTD., Haidian District, Beijing (CN); BEIJING JINGDONG CENTURY TRADING CO., LTD., Beijing (CN)

(72) Inventors: Kaitao ZHANG, Beijing (CN); Siyong YANG, Beijing (CN); Xiaoyue HAN, Beijing (CN); Fei WANG, Beijing (CN); Junhua LIU, Beijing (CN); Ran DAI, Beijing (CN)

(21) Appl. No.: 15/542,087

(22) PCT Filed: Dec. 30, 2015
(86) PCT No.: PCT/CN2015/099761

§ 371 Date: Jul. 7, 2017

(30) Foreign Application Priority Data
Jan. 9, 2015 (CN) 201510013224.0

(51) Int. Cl. G06F 17/30; G06Q 30/06; G06F 17/27; G06F 17/24

(52) U.S. Cl. CPC G06F 17/30997; G06F 17/30994; G06F 17/248; G06F 17/2705; G06Q 30/0641

(57) ABSTRACT

A page display method and system. The method comprises: obtaining stored metadata, wherein the metadata represents data describing commodity information (101); generating template data for page display according to the metadata (102); and according to the template data selecting a corresponding template rendering page, and then displaying the page to users (103). According to the method and system, the template data is generated through the stored metadata, a corresponding template rendering page is selected according to the template data and then displayed to users. In this way, there exists no dependence on systems having commodity information and no trouble is caused by the usability problem in these systems. Therefore, the page can be quickly displayed to users, improving user experience greatly and realizing diversified requirements of different people.

### TECHNICAL FIELD

The embodiments of the present invention relate to the technical field of Internet, and more particularly, to a page display method and system.

### BACKGROUND ART

In recent years, with the development of E-commerce websites, there may be billions of page views per day. Therefore, displaying commodity information to users quickly and displaying different commodity information for different users become important means of competition between E-commerce suppliers. However, due to the presence of massive information and the diversity of information needing to be displayed, if data requested by users are obtained directly from a system of the commodity information, for example, a plurality of systems possibly, rendered, combined and then displayed to users, it is difficult to meet the requirement of displaying to users quickly and it is dependent on the expansion of these systems.

To improve the efficiency of display, a static page generation technique is applied widely at present. If the commodity information changes, regenerating the page is needed. For example, if the commodity information of a certain supplier changes, all the commodity information of the supplier shall be regenerated, i.e., pages corresponding to all the commodity information of the supplier need to be regenerated. Or, static commodity pages may also be segmented, i.e., formed by multiple small file pages, and when the commodity information changes, incremental generation is used, i.e., small file pages corresponding to the changed commodity information are re-generated, and the segments are combined and displayed to users. Besides, if a change of page structure requires relevant pages to be re-generated, it will take several days or even several tens of days to be done. And when the entire page is formed by multiple small file pages, it is difficult to realize data backup and synchronization, and thus the expansion is poor.

### SUMMARY OF THE INVENTION

The embodiments of the present invention provide a page display method and system for displaying pages to users quickly, which improves user experience greatly.

The first aspect provides a page display method, comprising: obtaining stored metadata, wherein the metadata represents data for describing commodity information; generating template data for page display according to the metadata; and selecting, according to the template data, a corresponding template rendering page, and displaying the page.

In connection with the first aspect, in a possible implementation, before obtaining the stored metadata, the method further comprises generating the metadata according to the commodity information and storing the metadata.

In connection with the first aspect or any of the above implementations, in another possible implementation, upon learning that the commodity information has been modified, the stored metadata is modified according to the modified commodity information; or upon learning that the commodity information has been deleted, the stored metadata is deleted.

In connection with the first aspect or any of the above implementations, in another possible implementation, the method further comprises obtaining the commodity information from a source system of the commodity information using a parallelization technique.

In connection with the first aspect or any of the above implementations, in another possible implementation, the method further comprises merging and rearranging the stored metadata.

In connection with the first aspect or any of the above implementations, in another possible implementation, the metadata is stored with a key-value database.

In connection with the first aspect or any of the above implementations, in another possible implementation, the storage of the metadata is by means of database cluster fragmentation, and a master database server and at least one slave database server are provided in the database cluster, wherein the metadata stored in the master database server are backed-up in the at least one slave database server.

In connection with the first aspect or any of the above implementations, in another possible implementation, obtaining stored metadata comprises embedding Lua scripting language in a Nginx proxy server, and obtaining the stored metadata using the Lua scripting language.

In connection with the first aspect or any of the above implementations, in another possible implementation, generating template data for page display according to the metadata comprises parsing the metadata with JavaScript Object Notation (JSON) to obtain the template data.

In connection with the first aspect or any of the above implementations, in another possible implementation, obtaining stored metadata comprises obtaining stored metadata based on a message queue.

The second aspect provides a page display system, comprising a metadata storing sub-system, a template data sub-system and a page display sub-system, wherein the metadata storing sub-system is used for storing metadata which represents data for describing commodity information; the template data sub-system is used for obtaining the metadata stored in the metadata storing sub-system and generating template data for page display according to the metadata; and a dynamic page display sub-system for selecting, according to the template data generated by the template data sub-system, a corresponding template rendering page, and displaying the page.

In connection with the second aspect, in a possible implementation, the page display system further comprises a data heterogeneity sub-system that is used for generating the metadata according to the commodity information and sending the metadata to the metadata storing sub-system.

In connection with the second aspect or any of the above implementations, in another possible implementation, the page display system further comprises a data heterogeneity sub-system, wherein the data heterogeneity sub-system is used for, upon learning that the commodity information has been modified, modifying the metadata stored in the metadata storing sub-system according to modified commodity information; or for, upon learning that the commodity information has been deleted, deleting the metadata stored in the metadata storing sub-system.

In connection with the second aspect or any of the above implementations, in another possible implementation, the data heterogeneity sub-system is also used for obtaining the commodity information from a source system of the commodity information using a parallelization technique.

In connection with the second aspect or any of the above implementations, in another possible implementation, the metadata storing sub-system is also used for merging and rearranging the stored metadata.

In connection with the second aspect or any of the above implementations, in another possible implementation, the metadata storing sub-system is further used for storing the metadata with a key-value database.

In connection with the second aspect or any of the above implementations, in another possible implementation, the metadata storing sub-system is further used for storing the metadata with a database cluster fragmentation, wherein a master database server and at least one slave database server are provided in a database cluster, and the metadata stored in the master database server are backed-up in the at least one slave database server.

In connection with the second aspect or any of the above implementations, in another possible implementation, the template data sub-system is further used for embedding Lua scripting language in a Nginx proxy server, and the stored metadata is obtained with the Lua scripting language

In connection with the second aspect any of the above implementations, in another possible implementation, the template data sub-system is further used for parsing the metadata through JavaScript Object Notation (JSON) to obtain the template data.

In connection with the second aspect or any of the above implementations, in another possible implementation, the template data sub-system is further used for obtaining stored metadata based on a message queue.

In the embodiments of the present invention, by generating template data according to the stored metadata, selecting a corresponding template rendering page according to the template data, and displaying the page to users, it is independent on systems having commodity information, and is free of usability problems of the systems. Therefore, the page can be quickly displayed to users, improving user experience greatly and realizing diversified requirements of different people.

### BRIEF DESCRIPTION OF THE DRAWINGS

To explain the technical solutions of the embodiments of the present invention more clearly, the figures required to be used in the embodiments of the present invention is explained briefly below. Obviously, the following figures to be described are only some embodiments of the present invention, and to those skilled in the art, other figures may be obtained base on the following figures without creative work.

FIG. 1 is a schematic flowchart of the process of the page display method according to one embodiment of the present invention;

FIG. 2 is a schematic flowchart of the process of the page display method according to another embodiment of the present invention;

FIG. 3 is a schematic structure diagram of the page display system according to one embodiment of the present invention;

FIG. 4 is a schematic structure diagram of the page display system according to one embodiment of the present invention.

### DETAILED DESCRIPTION OF THE INVENTION

The technical solutions of the embodiments of the present invention will be described clearly and completely by in connection with the figures in the embodiments of the present invention. Obviously, the embodiments to be described are only part of the embodiments of the present invention rather than all of them. Based on the embodiments of the present invention, all other embodiments obtained by those skilled in the art without creative work will fall within the scope of the present invention.

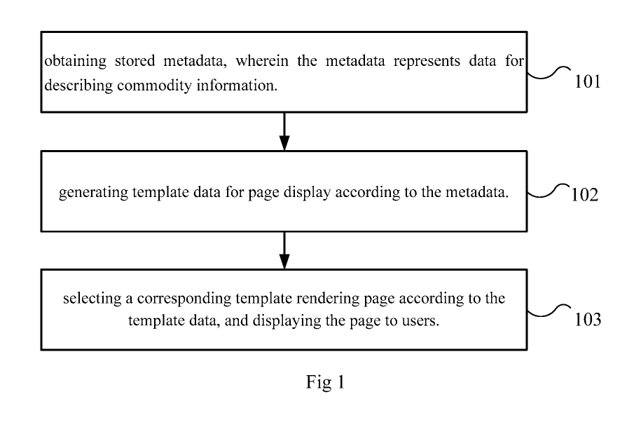

FIG. 1 is a schematic flowchart of the process of the page display method according to one embodiment of the present invention. The method of FIG. 1 may be performed by the page display system, which comprises:

Step 101: obtaining stored metadata, wherein the metadata represents data for describing commodity information.

A commodity may be one of any type, not limited in the present invention, which may be, for example, an air ticket, a book, a food item, a clothing item or other tangible products, or service type such as Ads, transactions, payments or other intangible products. Moreover, the business type involved in a commodity is not limited, which may be, for example, flash sales, panic buying or seckill. Metadata may also be referred as mediation data or relay data, which may refer to relevant information obtained from the source system of the commodity information, and which may be attributes of commodity information, such as the color of the clothing, size, brand, merchant or historical search data, etc.

Step 102: generating template data for page display according to the metadata.

The template data may be the processed color, size and the like, i.e., HTML elements required in pre-generating pages carried out in advance according to the requirement of page display, the page style, or the category of the commodity that are displayed to users.

Step 103: selecting a corresponding template rendering page according to the template data, and displaying the page to users.

It will be appreciated that the above examples are only exemplary to help to understand the embodiments of the present invention rather than to limit the scope of the present invention.

In the embodiments of the present invention, by generating template data according to the stored metadata, selecting a corresponding template rendering page according to the template data, and displaying the page to users, it is independent on systems having commodity information, and is free of usability problems of the systems. Therefore, the page can be quickly displayed to users, improving user experience greatly and realizing diversified requirements of different people.

Optionally, as an embodiment, before step 101, the method in FIG. 1 may generate the metadata according to the commodity information, and store the metadata. For example, upon learning that a commodity is newly added, information of the newly added commodity is obtained from a source system of the newly added commodity, and corresponding metadata is generated and stored.

Optionally, as another embodiment, upon learning that information on a certain commodity has been modified, a corresponding stored metadata is modified according to the modified commodity information; or upon learning that information on a certain commodity has been deleted, a corresponding stored metadata is deleted.

Specifically, a parallelization technique may be used to obtain the commodity information from the source system of the commodity information so as to reduce the delay of change (including modification, addition and/or deletion) of the commodity information. The obtained commodity information is filtered and processed according to a corresponding business logic to obtain the metadata, and the metadata is subjected to minimized processing so as to cope with frequent changes of data for page display.

By this solution, when a commodity is added or modified, it is unnecessary to depend on the expansion of the source system or to re-generate pages as with the static page generation technique, thereby updating the stored metadata quickly and having better expansion.

Optionally, as another embodiment, in step 101, Lua scripting language may be embedded into a proxy server, e.g., Nginx, which is a light Web server/reverse proxy server and an e-mail proxy server. The stored metadata is obtained by using Lua scripting language or of course other scripting languages. Database clusters may use a Twemproxy proxy of Twitter on fragmentations to simplify data fragmentation logic and to effectively reduce the number of connections of JIMDB/Redis.

Optionally, as another embodiment, in step 102, the metadata is parsed with JavaScript Object Notation (JSON) to obtain the template data. JIMDB has very good performance in data obtaining speed, of which the average time of obtaining data is for example, about 2 milliseconds in the case of hundreds of millions of level of key-value pairs with the size of less than 10 KB and a traffic of three hundred thousand times/per second per server with a gigabit network card. Besides, when the metadata is parsed with a JSON tool by a Nginx+Lua combination and pages are rendered, an average time of rendering is about 1 millisecond in the case of the size of the page being about 30-80 KB and a single server with a gigabit network card being requested 15,000-18,000 times per second. Therefore, the page can be displayed to users more quickly and user experience is greatly improved. Moreover, adopting Java language for implementation is convenient for expansion.

It will be appreciated that the above embodiment are only preferred modes of the present invention and the data in the example is only exemplary, not limiting the protection scope of the present invention.

Optionally, as another embodiment, in step 101, the stored metadata may be obtained based on a message queue. For example, in the case of deployment across computer rooms, queue pools of the message queue correspond to the computer rooms, and metadata is obtained from a corresponding queue pool; alternatively, queue pools correspond to types of business when different business require different page structures or template data; alternatively, priority is provided to commodity information, and in the case of high concurrency, metadata of a commodity information with high priority are obtained in priority. In this way, the requirement of business development can be better coped with.

Optionally, as another embodiment, the metadata may be stored with a key-value database (for example, a JIMDB key-value pair persistent database, which is a persistent storage engine combining Redis and LMDB (Lighting Memory-Mapped-Database)), more persistent data may be stored in an SSD (Solid State Disk), and local caching may use Redis. Storing metadata may be by means of database cluster fragmentation, and a master database server and at least one slave database server are provided in the database cluster, wherein the metadata stored in the master database server are backed-up in the at least one slave database server, that is, the databases (such as the JIMDB above) provide a function of master-slave copy. By means of Redis+LMDB, persistent storage can be fulfilled, data loss caused by power-off of the server will be avoided, and the problems of disaster recovery and expansion can be solved effectively by the function of master-slave copy.

And the stored metadata may be merged and re-arranged, not only to use the storage space effectively, but also to reduce repeated change of the metadata.

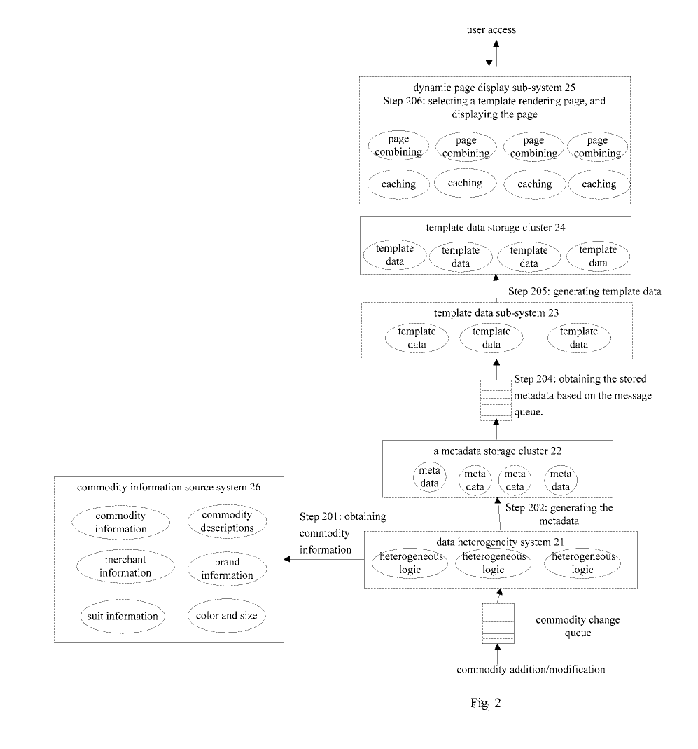

In connection with FIG. 2, embodiments of the present invention will be described below. FIG. 2 schematically shows a page display system, which comprises a data heterogeneity sub-system 21, a metadata storage cluster 22, a template data sub-system 23, a template data storage cluster 24 and a dynamic page display sub-system 25. FIG. 2 also shows a source system 26 of the commodity information. It shall be noted that the number of the metadata, the heterogeneous logic and the template data, and the commodity data described in FIG. 2 are only exemplary.

Step 201: the data heterogeneity sub-system 21 obtains commodity information from the source system 26 of the commodity information.

For example, when the data heterogeneity sub-system 21 learns that a certain commodity (assuming a clothing or shoes item) is added or the information of a certain commodity has been modified, a parallelization technique is used to obtain commodity information such as information of brand, information of suit, information of merchant, as well as color and size, from the commodity information system 26 so as to reduce the delay of change of the commodity information.

Step 202: the data heterogeneity sub-system 21 generates metadata according to the commodity information obtained in step 201.

Specifically, the obtained commodity information is filtered and processed according to a corresponding heterogeneous logic such as a business logic to obtain the metadata, and the metadata is subjected to minimized processing so as to cope with frequent changes of data for page display.

Step 203: the data heterogeneity sub-system 21 stores the metadata generated in step 202 into the metadata storage cluster 22.

Optionally, the metadata may be stored with a key-value database such as a JIMDB key-value pair persistent database, so as to perform persistent storage, and the JIMDB may provide the function of master-slave copy to effectively solve the problems of disaster recovery and expansion. The metadata is stored in fragmentation on the database cluster using the Twemproxy proxy of Twitter to simplify the data fragmentation logic and reduce the number of connections of JIMDB/Redis effectively. Moreover, the metadata storage cluster 22 may merge and re-arrange the stored metadata, to use the storage space effectively and to reduce repeated change of the metadata.

Step 204: the template data sub-system 23 obtains the stored metadata based on the message queue.

Step 205: the template data sub-system 23 generates template data for page display according to the metadata based on requirement of users' access, and stores the data into the template data storage cluster 24.

Step 206: the dynamic page display sub-system 25 selects a corresponding template rendering page according to the template data stored in the template data storage cluster 24, and displays it to users.

By this solution, the page can be quickly displayed to users, improving user experience greatly and realizing diversified requirements of different people.

In the embodiment of FIG. 2, some detailed examples may refer to the method embodiment in FIG. 1, and thereby is not repeated here.

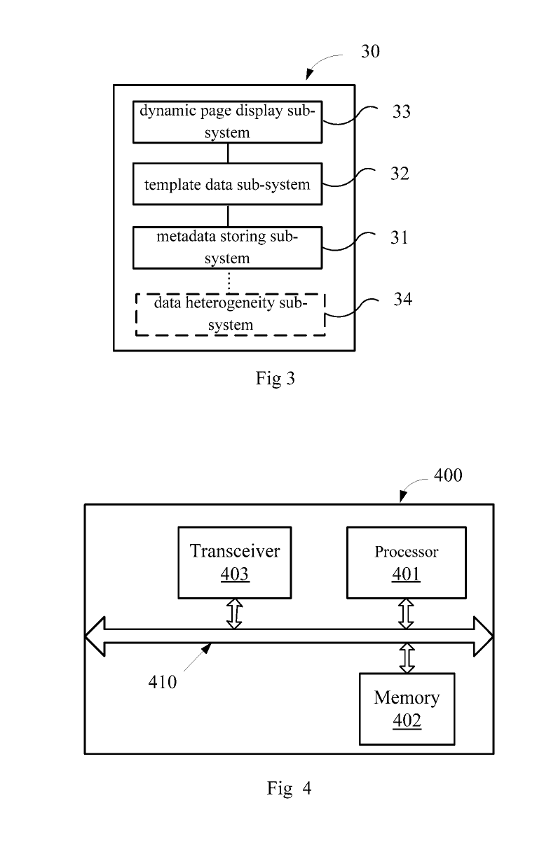

FIG. 3 shows a page display system according to one embodiment of the present invention, which comprises a metadata storing sub-system 31, a template data sub-system 32 and a dynamic page display sub-system 33.

The metadata storing sub-system 31 is used for storing metadata which represents data for describing commodity information;

The template data sub-system 32 is used for obtaining the metadata stored in the metadata storing sub-system 31 and generating template data for page display according to the metadata.

The dynamic page display sub-system 33 is used for selecting a corresponding template rendering page according to the template data generated by the template data sub-system 32, and displays the page to users.

In the embodiments of the present invention, by generating template data according to the stored metadata, selecting the corresponding template rendering page according to the template data, and displaying the page to users, it is independent on systems having commodity information, and is free of usability problems of the systems. Therefore, the page can be quickly displayed to users, improving user experience greatly and realizing diversified requirements of different people.

The page display system 30 (of which the page display system contained in FIG. 2 may regarded as an example) may realize the above method embodiment, and thereby is not described here in detail to avoid repeating.

Optionally, as an embodiment, the page display system 30 may further comprise a data heterogeneity sub-system 34 that is used for generating the metadata according to the commodity information and sending the metadata to the metadata storing sub-system 31. The data heterogeneity sub-system is used for, upon learning that the commodity information has been modified, modifying the metadata stored in the metadata storing sub-system 31 according to modified commodity information; or for, upon learning that the commodity information has been deleted, deleting the metadata stored in the metadata storing sub-system 31. By this solution, when a commodity is added or modified, it is unnecessary to depend on the expansion of the source system or to re-generate pages as with the static page generation technique, thereby updating the stored metadata quickly and having better expansion.

Further, the data heterogeneity sub-system 34 is also used for obtaining the commodity information from a source system of commodity information using a parallelization technique so as to reduce the delay of change of the commodity information. The data heterogeneity sub-system 34 may also be used for filtering and processing the obtained commodity information according to a corresponding business logic to obtain the metadata, and the metadata is subjected to minimized processing so as to cope with frequent changes of data for page display.

Optionally, as another embodiment, the metadata storing sub-system 31 may also be used for merging and re-arranging the stored metadata, thereby not only to use the storage space effectively, but also to reduce repeated change of the metadata.

Optionally, as another embodiment, the metadata storing sub-system 31 may further be used for storing the metadata with a key-value database (e.g. JIMDB key-value pair persistent database, which is a persistent engine combining Redis and LAMB). Specifically, the metadata storing sub-system may further be used for storing the metadata by means of database cluster fragmentation, wherein a master database server and at least one slave database server are provided in a database cluster, and the metadata stored in the master database server are backed-up in the at least one slave database server. The usage of Redis+LMDB can perform persistent storage, data loss caused by power-off of the server will be avoided, and the problems of disaster recovery and expansion can be solved effectively by the function of master-slave copy.

Optionally, as another embodiment, the template data sub-system 32 may further be used for embedding Lua scripting language in a Nginx proxy server, and obtaining the stored metadata using the Lua scripting language.

Optionally, as another embodiment, the template data sub-system 32 may further parse the metadata by JavaScript Object Notation (JSON) to obtain the template data. Therefore, the page can be quickly displayed to users, improving user experience greatly. Moreover, implementation with Java language is convenient for expansion.

Optionally, as another embodiment, the template data sub-system 32 may further be used for obtaining the stored metadata based on a message queue. Refer to the above method embodiment for specific examples, which are not repeated here.

The method disclosed in the above embodiment in the present invention may be implemented using a page display system shown in FIG. 4. A page display system 400 comprises a processor 401, a memory 402 and a transceiver 403. The processor 401 controls the operation of device 400, and the memory 402 may comprise a read-only memory and a random access memory, and provide instructions and data to the processor 401. A portion of the memory 402 may comprise a non-volatile random access memory (NVRAM). The processor 401, the memory 402 and the transceiver 403 are coupled together with a bus system 410. The bus system 410 comprises not only a data bus but also a power bus, a control bus and a status signal bus. However, for a clear explanation, all the buses in the figure are denoted as the bus system 410.

The processor 401 may be an integrated circuit chip that has the signal processing capability. During the implementation process, steps of the above method may be completed by integrated logic circuits of hardware or instructions in the form of software in the processor 401. The processor 401 may be a general-purpose processor comprising CPU (Central Processing Unit), NP (Network Processor) and so on; DSP (Digital Signal Processing), ASIC (Application Specific Integrated Circuit) and FPGA (Field Programmable Gate Array); or other programmable logic devices, discrete gate or transistor logic device and discrete hardware component. The methods, steps and logic diagrams disclosed in the embodiments of the present invention can be performed or achieved. The general-purpose processor may be a microprocessor or any conventional processor.

The those skilled in the art may realize that the sub-systems and the steps of algorithm in the examples described by in connection with the embodiments disclosed in the text can be embodied in the form of electronic hardware, computer software or the combination of the two, and to describe the interchangeability of the hardware and the software clearly, the components and steps of each of the examples are described in the above explanations generally according to functions. Whether these functions are perform by way of hardware or software depends on the specific application and restrictive conditions on design of the technical solutions. The technicians may implement the described functions of each specific application using different methods, but such implementation shall not exceed the scope of the present invention.

It will be appreciated that the systems, devices and methods disclosed in several embodiments provided in the present application may be embodied by other means. For example, the device embodiments described in the above are only exemplary, e.g., the division of the sub-systems is only one type of logical function division, and in actual implementations other division manners can be adopted, which, for example, involves that multiple sub-systems or components can be combined or integrated into another system, or some features can be ignored or not be performed.

Furthermore, the sub-systems of functions in the respective embodiments of the present invention may be integrated into a single processing unit, or be presented physically separated; or two or more sub-systems may be integrated into one sub-system.

When embodied in the form of software functions and are sold or used as individual products, the functions may be stored in computer readable storage medium. Based on such understanding, the technical solution in the present invention, the part of the present invention that makes contributions to the prior art, or part of the technical solution can be substantively embodied in the form of software products, this computer software product is stored in a storage medium, and contains several instructions for enabling a computer device, such as a personal computer, a server or a network device, to perform all or part of the steps of the method in the embodiments of the present invention. The storage medium mentioned above include U disk, mobile hard disk, ROM (Read-Only Memory), RAM (Random Access Memory), diskette, optical disk, and any other medium that can store program codes.

What described in the above are only the particular embodiments of the present invention. However, the protection scope of the present invention is not limited here, and any change or replacement that can be thought of by those skilled in the art within the field of the present invention should fall within the scope of the present invention. Therefore, the protection scope of the present invention shall be based on the protection scope of the claims.

1. A page display method, characterized by comprising:
obtaining stored metadata, wherein the metadata represents data for describing commodity information;
generating template data for page display according to the metadata; and
selecting a corresponding template rendering page according to the template data, and displaying the page to a user.

2. The method according to claim 1, characterized in that before obtaining the stored metadata, further comprising:
generating the metadata according to the commodity information and storing the metadata.

3. The method according to claim 1, characterized in that further comprising:
upon learning that the commodity information has been modified, modifying corresponding stored metadata according to the modified commodity information; or
upon learning that the commodity information has been deleted, deleting corresponding stored metadata.

4. The method according to claim 2, characterized in that further comprising:
obtaining the commodity information from a source system of the commodity information using a parallelization technique.

5. The method according to claim 1, characterized in that further comprising:
merging and rearranging the stored metadata.

6. The method according to claim 1, characterized in that the metadata is stored using a key-value database.

7. The method according to claim 6, characterized in that the metadata is stored by means of database cluster fragmentation, and a master database server and at least one slave database server are provided in the database cluster, wherein the metadata stored in the master database server is backed-up in the at least one slave database server.

8. The method according to claim 1, characterized in that
obtaining the stored metadata comprises embedding Lua scripting language in a Nginx proxy server, and obtaining the stored metadata using the Lua scripting language.

9. The method according to claim 1, characterized in that generating the template data for page display according to the metadata comprises
obtaining the template data by parsing the metadata with JavaScript Object Notation (JSON).

10. The method according to claim 1, characterized in that
obtaining the stored metadata comprises obtaining stored metadata based on a message queue.

11. A page display system, characterized by comprising a metadata storing sub-system, a template data sub-system and a page display sub-system, wherein
the metadata storing sub-system is used for storing metadata which represents data for describing commodity information;
the template data sub-system is used for obtaining the metadata stored in the metadata storing sub-system and generating template data for page display according to the metadata; and
the dynamic page display sub-system is used for selecting a corresponding template rendering page according to the template data generated by the template data sub-system, and displaying the page.

12. The system according to claim 11, characterized in that the page display system further comprises a data heterogeneity sub-system that is used for generating the metadata according to the commodity information and sending the metadata to the metadata storing sub-system.

13. The system according to claim 11, characterized in that the page display system further comprises a data heterogeneity sub-system, wherein the data heterogeneity sub-system is used for, upon learning that the commodity information has been modified, modifying the metadata stored in the metadata storing sub-system according to modified commodity information; or the data heterogeneity sub-system is used for, upon learning that the commodity information has been deleted, deleting the metadata stored in the metadata storing sub-system.

14. The system according to claim 12, characterized in that
the data heterogeneity sub-system is also used for obtaining the commodity information from a source system of the commodity information using a parallelization technique.

15. The system according to claim 11, characterized in that the metadata storing sub-system is also used for merging and rearranging the stored metadata.

16. The system according to claim 11, characterized in that the metadata storing sub-system is further used for storing the metadata with a key-value database.

17. The system according to claim 16, characterized in that the metadata storing sub-system is further used for storing the metadata by means of database cluster fragmentation, wherein a master database server and at least one slave database server are provided in the database cluster, and the metadata stored in the master database server is backed-up in the at least one slave database server.

18. The system according to claim 11, characterized in that
the template data sub-system is further used for embedding Lua scripting language in a Nginx proxy server.

19. The system according to claim 11, characterized in that
the template data sub-system is further used for obtaining the stored metadata using the Lua scripting language, and obtaining the template data by parsing the metadata with JavaScript Object Notation (JSON).

20. The system according to any of claim 11, characterized in that the template data sub-system is further used for obtaining stored metadata based on a message queue.
